(19) United States
(12) Patent Application Publication
(10) Pub. No.: US 2025/0277771 A1
(43) Pub. Date: Sep. 4, 2025

(54) PAPER SHEET HANDLING APPARATUS AND FOREIGN SUBSTANCE DETECTION METHOD

(71) Applicants: FUJITSU FRONTECH LIMITED, Tokyo (JP); Fujitsu Frontech Systems Limited, Maebashi-shi (JP)

(72) Inventor: Yuqing WENG, Inagi (JP)

(73) Assignees: FUJITSU FRONTECH LIMITED, Tokyo (JP); Fujitsu Frontech Systems Limited, Maebashi-shi (JP)

(21) Appl. No.: 19/210,564

(22) Filed: May 16, 2025

Related U.S. Application Data
(63) Continuation of application No. PCT/JP2022/045195, filed on Dec. 7, 2022.

(51) Int. Cl. G01N 29/04; B65H 5/00; B65H 5/04; B65H 5/06; G01N 29/12; G07D 7/08; G07D 11/16

(52) U.S. Cl. CPC G01N 29/045; B65H 5/006; B65H 5/04; B65H 5/062; G01N 29/12; G07D 7/08; G07D 11/16; B65H 2301/152; B65H 2301/542; B65H 2404/1441; B65H 2553/30; B65H 2701/1912; G07D 2207/00; G07D 2211/00

(57) ABSTRACT

A paper sheet handling apparatus includes: a conveyance path on which a bundle of paper sheets is conveyed; and a detector including a plurality of ultrasonic wave sensors, which is arranged on the conveyance path, and detecting presence or absence of a foreign substance, which is mixed in the bundle of paper sheets by the plurality of ultrasonic wave sensors. The detector causes the plurality of ultrasonic wave sensors to respectively irradiate, with ultrasonic waves, a plurality of positions on a paper surface of the bundle of paper sheets, which is conveyed along the conveyance path, and detects the presence or absence of the foreign substance based on reflected waves of the ultrasonic waves from the plurality of positions.

### CROSS-REFERENCE TO RELATED APPLICATION(S)

This application is a continuation of International Application No. PCT/JP2022/045195, filed on Dec. 7, 2022, the entire contents of which are incorporated herein by reference.

### FIELD

The present invention relates to a paper sheet handling apparatus and a foreign substance detection method.

### BACKGROUND

As a paper sheet handling apparatus, for example, a banknote handling apparatus such as an automated teller machine is known. As this type of banknote handling apparatus, for example, there is a case in which a banknote clip for bundling banknotes or a foreign substance such as a coin is mixed in the banknote to be input, and a banknote handling apparatus including a detector that is configured to detect the presence or absence of the foreign substance mixed in the banknote is known.

As such a detector, for example, there is a detector including a metal sensor that detects a foreign substance based on the amount of metal, which is mixed in a banknote. However, in a case of handling a banknote, which has a large metal content of the banknote itself subjected to magnetic printing or the like, the metal sensor may erroneously detect that a foreign substance is mixed even in a banknote in which a foreign substance is not mixed. In addition, the metal sensor may erroneously detect, as a foreign substance, a metal plate or the like existing around a place at which the metal sensor is disposed in the banknote handling apparatus. In addition, there is a detector configured to irradiate a banknote with an ultrasonic wave by an ultrasonic wave sensor instead of a metal sensor, and to detect the presence or absence of a foreign substance based on the transmission amount (sound wave amount) of the transmitted wave of the ultrasonic wave, which is transmitted through the banknote.
Patent Literature 1: JP 2012-189497 A
Patent Literature 2: JP 2001-351141 A

As described above, the detector including the ultrasonic wave sensor uses the transmission amount of the transmitted wave of the ultrasonic wave, which is transmitted through one banknote as a reference value, and detects that there is a foreign substance when the transmission amount of the ultrasonic wave becomes smaller than the reference value. Since the detection is performed based on the transmission amount of the ultrasonic wave in this manner, in a case where a plurality of banknote bundles is handled, it is difficult to detect a foreign substance due to a decrease in the transmission amount of the transmitted wave, which is transmitted through the plurality of banknote bundles. Therefore, there is a problem in that detection accuracy of the presence or absence of the foreign substance mixed in the banknote bundle deteriorates.

### SUMMARY

According to an aspect of an embodiment, a paper sheet handling apparatus includes: a conveyance path on which a bundle of paper sheets is conveyed; and a detector that includes a plurality of ultrasonic wave sensors, which is arranged on the conveyance path, and detects, by the plurality of ultrasonic wave sensors, presence or absence of a foreign substance that is mixed in the bundle of paper sheets, wherein the detector causes the plurality of ultrasonic wave sensors to respectively irradiate, with ultrasonic waves, a plurality of positions on a paper surface of the bundle of paper sheets, which is conveyed along the conveyance path, and detects the presence or absence of the foreign substance based on reflected waves of the ultrasonic waves from the plurality of positions.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a longitudinal cross-sectional view schematically illustrating a banknote handling apparatus according to an embodiment;

FIG. 2 is a transverse cross-sectional view schematically illustrating the banknote handling apparatus according to the embodiment;

FIG. 3 is a longitudinal cross-sectional view for describing the operation of a conveyance mechanism according to the embodiment;

FIG. 4 is a plan view schematically illustrating a detector according to the embodiment;

FIG. 5 is a schematic diagram for describing the principle of detecting a foreign substance in the embodiment;

FIG. 6 is a schematic diagram for describing the principle of detecting a foreign substance in the embodiment;

FIG. 7 is a flowchart for describing a foreign substance detection operation in the banknote handling apparatus according to the embodiment; and

FIG. 8 is a schematic diagram for describing a state in which detection of the presence or absence of a foreign substance is repeated a plurality of times at regular intervals in the conveyance direction of a conveyance path in the embodiment.

### DESCRIPTION OF EMBODIMENTS

Hereinafter, embodiments of a paper sheet handling apparatus and a foreign substance detection method disclosed in the present application, will be described in detail with reference to the drawings. Note that the paper sheet handling apparatus and the foreign substance detection method, disclosed in the present application, are not limited by the following embodiments.

### EMBODIMENT

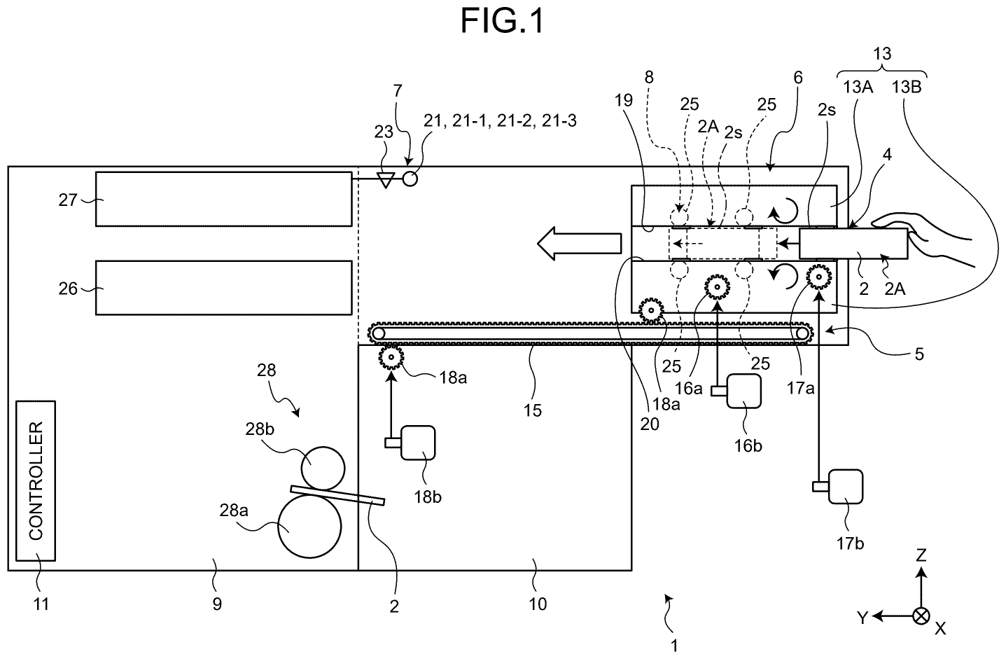

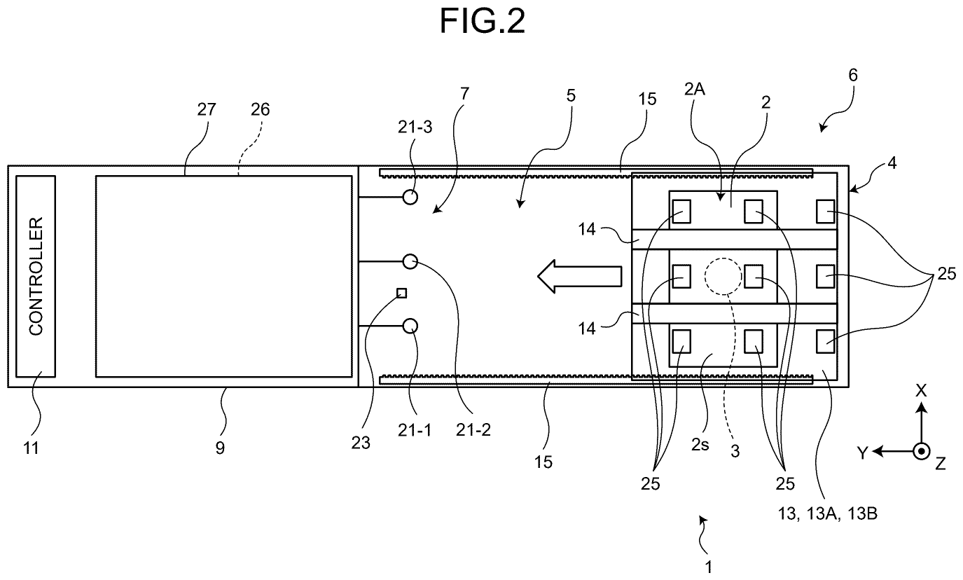

Configuration of Banknote Handling Apparatus FIG. 1 is a longitudinal cross-sectional view schematically illustrating a banknote handling apparatus according to an embodiment. FIG. 2 is a transverse cross-sectional view schematically illustrating the banknote handling apparatus according to the embodiment.

As illustrated in FIGS. 1 and 2, a banknote handling apparatus 1 according to the embodiment includes an insertion port (deposition port) 4 into which a banknote bundle 2A to be deposited is inserted, a conveyance path 5 through which the deposited banknote bundle 2A is conveyed, a conveyance mechanism 6 that conveys the banknote bundle 2A along the conveyance path 5, a detector 7 that is configured to detect presence or absence of a foreign substance 3, which is mixed in the banknote bundle 2A, by a plurality of ultrasonic wave sensors, and a presser 8 that is configured to press the banknote bundle 2A, which is conveyed along the conveyance path 5 in a thickness direction of the banknote bundle 2A. The banknote handling apparatus 1 further includes a storage section 9 that is configured to store the banknote bundle 2A, which is conveyed by the conveyance mechanism 6, a distinguishing section 10 that is configured to distinguish authenticity of the banknote 2, which is sent from the storage section 9, and a controller 11 that is configured to control the respective sections 5 to 10.

For convenience of description, in FIG. 1, when the banknote handling apparatus 1 is viewed from the front side where the insertion port 4 is located, the width direction of the banknote handling apparatus 1 is referred to as an X direction, the forward-and-rearward direction of the banknote handling apparatus 1 is referred to as a Y direction, and the vertical direction of the banknote handling apparatus 1 is referred to as a Z direction. Similarly to FIG. 1, the X, Y, and Z directions are illustrated in FIG. 1 and subsequent drawings. In the present embodiment, the banknote 2 is used as an example of the paper sheet, but the paper sheet is not limited to the banknote 2. The paper sheet includes, for example, securities such as a draft, a check, a gift certificate, various securities, and a stock certificate.

Further, in the present embodiment, the banknote bundle 2A refers to, for example, a bundle in which about 100 to 200 banknotes 2 are stacked, but the number of the banknotes 2 in the banknote bundle 2A is not limited. The banknote bundle 2A according to the embodiment includes, for example, a bundle in which two banknotes 2 are stacked. The foreign substance 3 to be detected by the detector 7, is not limited to a coin, a clip, and the like present inside the banknote bundle 2A, and includes a coin placed on a paper surface 2s of the banknote bundle 2A, a clip located on the paper surface 2s of the banknote bundle 2A, and the like.

### Conveyance Path

The banknote bundle 2A is inserted into the insertion port 4 along the short side of the rectangular banknote 2. The conveyance path 5 is provided along an insertion direction (Y direction) of the banknote bundle 2A with respect to the insertion port 4. Therefore, the banknote bundle 2A is conveyed along the short side of the banknote 2 on the conveyance path 5.

### Conveyance Mechanism

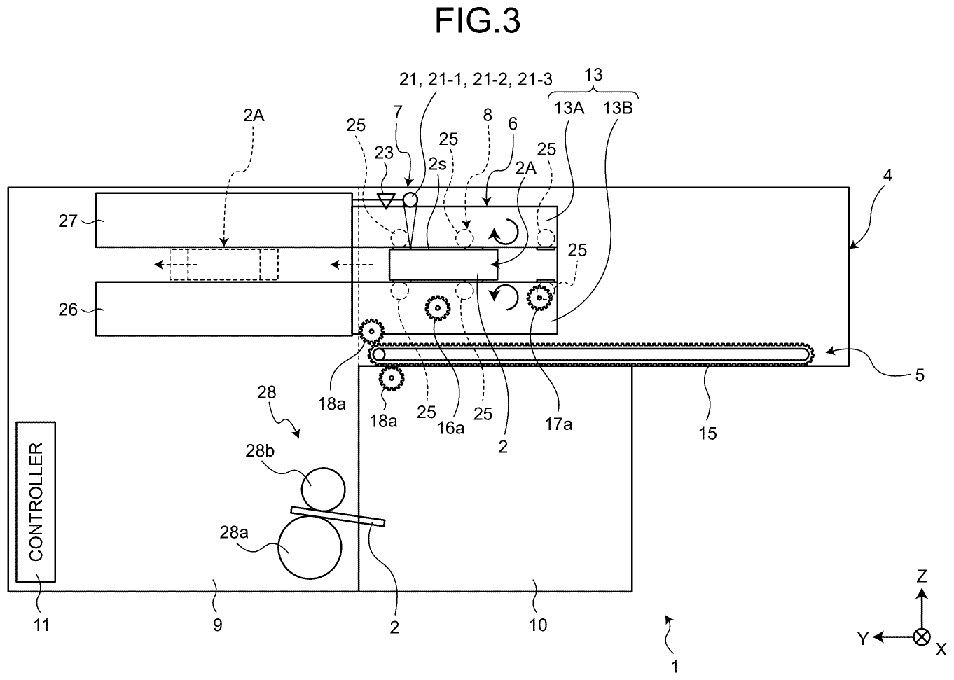

FIG. 3 is a longitudinal cross-sectional view for describing the operation of the conveyance mechanism 6 according to the embodiment. As illustrated in FIGS. 2 and 3, the conveyance mechanism 6 includes a shuttle 13 that reciprocates along the conveyance path 5, a transfer belt 14 that moves the banknote bundle 2A with respect to the shuttle 13, and a conveyance belt 15 that conveys the shuttle 13 along the conveyance path 5. Further, the conveyance mechanism 6 includes a gear 16a and a motor 16b that raise and lower an upper shuttle member 13A (described later) included in the shuttle 13, a gear 17a and a motor 17b that drive the transfer belt 14, and a gear 18a and a motor 18b that drive the conveyance belt 15.

The shuttle 13 includes the upper shuttle member 13A and a lower shuttle member 13B as a pair of conveyance members that convey the banknote bundle 2A in a state of sandwiching the banknote bundle 2A in the thickness direction (Z direction) of the banknote bundle 2A. The lower shuttle member 13B has a placement surface 20 that is configured for the banknote bundle 2A inserted from the insertion port 4 to be placed thereon. The upper shuttle member 13A is provided to be movable upwards and downwards in the Z direction so as to sandwich the banknote bundle 2A between the upper shuttle member 13A and the placement surface 20 of the lower shuttle member 13B. The shuttle 13 is provided with an insertion sensor (not illustrated) that detects insertion of the banknote bundle 2A into the shuttle 13, and when the insertion of the banknote bundle 2A from the insertion port 4, is detected, the upper shuttle member 13A is lowered toward the lower shuttle member 13B by the conveyance mechanism 6.

When the banknote bundle 2A is inserted into the lower shuttle member 13B from the insertion port 4, the upper shuttle member 13A is lowered by the gear 16a and the motor 16b, thereby sandwiching the banknote bundle 2A between the upper shuttle member and the lower shuttle member 13B. As a result, the conveyance mechanism 6 conveys the banknote bundle 2A by the upper shuttle member 13A and the lower shuttle member 13B in a state in which the banknote bundle 2A is sandwiched therebetween in the thickness direction (Z direction) of the banknote bundle 2A. In addition, the upper shuttle member 13A is formed to have a shape that does not block the ultrasonic wave emitted from the detector 7 toward the paper surface 2s of the banknote bundle 2A.

The transfer belt 14 is provided on the upper shuttle member 13A and the lower shuttle member 13B so as to move in the conveyance direction (Y direction) along a lower surface 19 of the upper shuttle member 13A and the placement surface 20 of the lower shuttle member 13B. The transfer belt 14 moves the banknote bundle 2A placed on the placement surface 20 so as to draw the banknote bundle 2A toward the back side (the storage section 9 side) in the shuttle 13. Further, the transfer belt 14 moves the banknote bundle 2A in the shuttle 13 to the inside of the storage section 9 after the shuttle 13 is conveyed to the storage section 9.

The conveyance belts 15 are respectively disposed, in the conveyance direction (Y direction), on opposite sides of the conveyance path 5 in the width direction (X direction), and support the lower shuttle member 13B of the shuttle 13 with the gear 18a interposed therebetween. The conveyance mechanism 6 conveys the banknote bundle 2A, which is inserted from the insertion port 4, to the storage section 9 along the conveyance path 5 by sending the shuttle 13 that is configured for the banknote bundle 2A to be placed thereon by the conveyance belt 15.

Further, the shuttle 13 is provided with the presser 8, and a plurality of rollers 25 (to be described later) of presser 8 is disposed on the upper shuttle member 13A and the lower shuttle member 13B.

### Detector

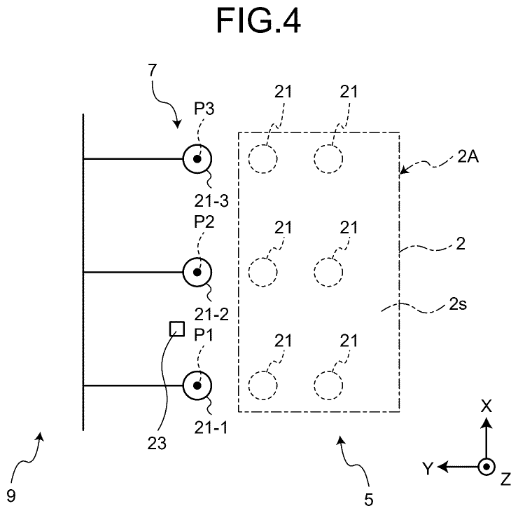

FIG. 4 is a plan view schematically illustrating the detector 7 according to the embodiment. As illustrated in FIG. 4, the detector 7 in the embodiment includes, as an example, a first ultrasonic wave sensor 21-1, a second ultrasonic wave sensor 21-2, and a third ultrasonic wave sensor 21-3 (hereinafter, also referred to as each ultrasonic wave sensor 21), and is electrically connected to the controller 11. Although not illustrated, each of the ultrasonic wave sensors 21 includes a transmitter that emits an ultrasonic wave toward the paper surface 2s of the banknote bundle 2A, and a receiver that receives a reflected wave of the ultrasonic wave from the paper surface 2s of the banknote bundle 2A, and sends a detection signal, indicating that the receiver has detected the reflected wave, to the controller 11.

As the controller 11 in the present embodiment, a control circuit of a control board, which is provided inside the banknote handling apparatus 1, is used, but the present invention is not limited thereto, and an external computer, which is connected to the banknote handling apparatus 1, may be used.

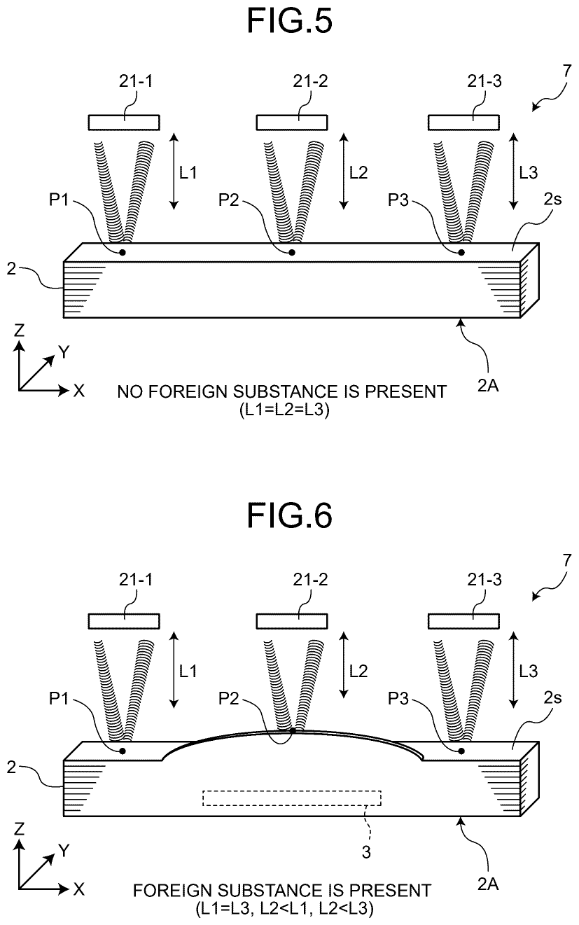

The detector 7 is configured to cause the plurality of ultrasonic wave sensors 21 (for example, the first ultrasonic wave sensor 21-1, the second ultrasonic wave sensor 21-2, and the third ultrasonic wave sensor 21-3) to respectively emit ultrasonic waves toward a plurality of positions (for example, a first position P1, a second position P2, and a third position P3) on the paper surface 2s of the banknote bundle 2A, which is conveyed along the conveyance path 5 (refer to FIGS. 5 and 6), and to detect the presence or absence of the foreign substance 3 based on the respective reflected waves of the ultrasonic waves from the plurality of positions.

In the embodiment, the controller 11 determines the presence or absence of the foreign substance 3 based on the detection signal from each ultrasonic wave sensor 21, but the transmission of the detection signal to the controller 11 by each ultrasonic wave sensor 21 of the detector 7, is defined as the detection of the presence or absence of the foreign substance 3 by the detector 7. In addition, the detector 7 may include an arithmetic processor that is configured to determine the presence or absence of the foreign substance 3 based on the detection signal of each ultrasonic wave sensor 21 independently of the controller 11. Further, the paper surface 2s of the banknote bundle 2A refers to the front surface of the banknote 2, which faces each of the ultrasonic wave sensors 21, and for example, refers to the printing surface of the uppermost banknote 2 in the banknote bundle 2A.

The respective ultrasonic wave sensors 21 are arranged with an interval therebetween in the width direction (X direction) of the conveyance path 5 orthogonal to the conveyance direction (Y direction) on the plane (X-Y plane) orthogonal to the thickness direction (Z direction) of the banknote bundle 2A, which is conveyed along the conveyance path 5. In other words, the ultrasonic wave sensors 21 are arranged with an interval therebetween in the long side direction (X direction) of the banknote 2 in the banknote bundle 2A, which is conveyed along the conveyance path 5. The interval between the ultrasonic wave sensors 21 is set to, for example, about the average diameter dimension of a plurality of types of coins that is the foreign substance 3. Each ultrasonic wave sensor 21 is supported by, for example, a structure such as a top plate of the banknote handling apparatus 1, which faces the conveyance path 5.

In the present embodiment, the ultrasonic wave sensors 21 are arranged with an interval therebetween in the width direction (X direction) of the conveyance path 5, but the arrangement thereof is not limited thereto. For example, as illustrated in FIG. 4, the ultrasonic wave sensors 21 may be arranged with an interval therebetween in the conveyance direction (Y direction) of the banknote bundle 2A. In addition, the plurality of ultrasonic wave sensors 21 may be arranged in a grid pattern on a plane (X-Y plane) orthogonal to the thickness direction (Z direction) of the banknote bundle 2A, which is conveyed along the conveyance path 5, that is, may be arranged with an equal interval therebetween in the conveyance direction (Y direction) and the width direction (X direction) of the conveyance path 5. Since the plurality of ultrasonic wave sensors 21 are arranged in the grid pattern, it is possible to increase the detection accuracy of the foreign substance 3, and to quickly detect the foreign substance 3 in a predetermined range of the paper surface 2s of the banknote bundle 2A.

Although details will be described later, each of the ultrasonic wave sensors 21 is set so as to irradiate the paper surface 2s of the banknote bundle 2A with an ultrasonic wave having a frequency of 3.4 [MHz] or more. As a result, the detector 7 can detect whether the change amount (bulging amount) of the paper surface 2s, which is bulged by the foreign substance 3, or the change amount due to bulging of the foreign substance 3 on the paper surface 2s is, for example, 1.0 [mm] or more with detection accuracy of resolution of 0.1 [mm] or less. Based on the detection result of the detector 7, the controller 11 determines that the foreign substance 3 is not present in the banknote bundle 2A (no foreign substance is present), or the foreign substance 3 is present in the banknote bundle 2A (foreign substance is present).

In addition, the detector 7 includes a position sensor 23 that detects the banknote bundle 2A, which is conveyed to the position of each ultrasonic wave sensor 21 by the conveyance mechanism 6. The position sensor 23 is disposed in the vicinity of any one of the first ultrasonic wave sensor 21-1, the second ultrasonic wave sensor 21-2, and the third ultrasonic wave sensor 21-3, and is electrically connected to the controller 11. As the position sensor 23, for example, a reflection type optical sensor or a transmission type optical sensor is used. The position sensor 23 detects the arrival of the banknote bundle 2A at the position of each ultrasonic wave sensor 21 when detection light, emitted from the position sensor 23, is blocked by, for example, the banknote bundle 2A or the shuttle 13, and transmits a detection signal to the controller 11. The controller 11 causes the detector 7 to start detection based on the detection signal.

Therefore, after detecting the arrival of the banknote bundle 2A at the position of each ultrasonic wave sensor 21, the detector 7 starts detection of the presence or absence of the foreign substance 3 in the banknote bundle 2A. When the detector 7 detects the presence or absence of the foreign substance 3, the detection is performed while the banknote bundle 2A is conveyed by the conveyance mechanism 6, but the detection may be performed by temporarily stopping the conveyance of the banknote bundle 2A.

In addition, although details will be described later, the detector 7 intermittently repeats detection of the presence or absence of the foreign substance 3, that is, detection of irradiating the paper surface 2s of the banknote bundle 2A with the ultrasonic wave from each ultrasonic wave sensor 21 respectively and receiving the reflected wave of the ultrasonic wave from the paper surface 2s a plurality of times at regular intervals in the conveyance direction (Y direction) of the conveyance path 5 with respect to the paper surface 2s of the banknote bundle 2A.

### Presser

As illustrated in FIG. 2, the presser 8 includes a plurality of rollers 25 that press the banknote bundle 2A, which is conveyed along the conveyance path 5 in the thickness direction (Z direction) of the banknote bundle 2A. The plurality of rollers 25 is respectively provided on opposite surfaces of the upper shuttle member 13A and the lower shuttle member 13B, in which the opposite surfaces face each other, that is, the lower surface 19 of the upper shuttle member 13A and the placement surface 20 of the lower shuttle member 13B. In other words, the plurality of rollers 25 is arranged on both sides in the thickness direction (Z direction) of the banknote bundle 2A, which is placed on the shuttle 13, that is, on both sides in the vertical direction (Z direction) of the conveyance path 5.

Since the banknote bundle 2A is pressed from both sides in the thickness direction (Z direction) by the plurality of rollers 25, which is arranged in this manner, the bulging of the paper surface 2s, which is caused by the wrinkles or the folding habit of the banknote bundle 2A, is suppressed, and the change in the paper surface 2s due to such bulging, can be avoided, thereby making it possible to appropriately detect the bulging due to the foreign substance 3, and to improve detection accuracy of the foreign substance 3.

Note that the plurality of rollers 25 is arranged on both sides in the thickness direction (Z direction) of the banknote bundle 2A so as to enhance the action of pressing the banknote bundle 2A in the thickness direction (Z direction), but the present invention is not limited thereto, and the plurality of rollers may be provided only on one side in the thickness direction (Z direction) of the banknote bundle 2A.

In addition, the plurality of rollers 25 is arranged in the grid pattern on the plane (X-Y plane) orthogonal to the thickness direction (Z direction) of the banknote bundle 2A, which is conveyed along the conveyance path 5. In the embodiment, as an example, a total of nine rollers 25 are arranged with an interval therebetween in the conveyance direction (Y direction) of the conveyance path 5 and the width direction (X direction) of the conveyance path 5, in which three rollers are arranged in each direction.

The banknote bundle 2A, which is inserted into the shuttle 13 from the insertion port 4, is sandwiched between the upper shuttle member 13A and the lower shuttle member 13B, and then is sent along the conveyance direction (Y direction) by the transfer belt 14, thereby moving from the insertion port 4 side to the storage section 9 side in the shuttle 13. When the banknote bundle 2A is moved in the shuttle 13 in this manner, the banknote bundle 2A is pressed in the thickness direction (Z direction) thereof by the plurality of rollers 25, and the bulging of the paper surface 2s, described above, is suppressed. Therefore, in the conveyance mechanism 6, the transfer belt 14, which is provided in the lower shuttle member 13B, corresponds to a moving member that moves the banknote bundle 2A, which is sandwiched between the pair of upper shuttle members 13A and the lower shuttle member 13B, with respect to the plurality of rollers 25.

### Storage Section

As illustrated in FIGS. 1, 2, and 3, the storage section 9 includes a stage 26 on which the banknote bundle 2A, received from the shuttle 13 of the conveyance mechanism 6, is placed, a pusher member 27 that presses the banknote bundle 2A on the stage 26, an upward-and-downward mechanism (not illustrated) that moves the stage 26 and the pusher member 27 upwards and downwards in the Z direction, and a feeding mechanism 28 that sends the banknote 2 of the banknote bundle 2A on the stage 26 to the distinguishing section 10. The feeding mechanism 28 includes a pickup roller 28a that sends the banknote 2 from the banknote bundle 2A on the stage 26, a separation roller 28b that separates the banknote 2 in the banknote bundle 2A one by one, and gears and motors (not illustrated) that drive the respective rollers 28a and 28b.

In the storage section 9, after the banknote bundle 2A, which is sent by the conveyance mechanism 6, is placed on the stage 26, the stage 26 is moved downwards together with the pusher member 27, and the banknotes 2 are sent one by one from the banknote bundle 2A on the stage 26 to the distinguishing section 10 by the feeding mechanism 28. The banknotes 2, which is sent one by one from the storage section 9 in this manner, are distinguished by the distinguishing section 10.

### Principle of Detection of Foreign Substance Mixed in Banknote Bundle

FIGS. 5 and 6 are schematic diagrams for describing the principle of detecting the foreign substance 3 in the embodiment. FIG. 5 illustrates a case in which there is no foreign substance in the banknote bundle 2A, and FIG. 6 illustrates a case in which there is a foreign substance in the banknote bundle 2A.

As illustrated in FIGS. 5 and 6, the controller 11 causes the detector 7 to measure a first distance L1 between the first ultrasonic wave sensor 21-1 and the first position P1 of the paper surface 2s of the banknote bundle 2A, a second distance L2 between the second ultrasonic wave sensor 21-2 and the second position P2 of the paper surface 2s of the banknote bundle 2A, and a third distance L3 between the third ultrasonic wave sensor 21-3 and the third position P3 of the paper surface 2s of the banknote bundle 2A.

Each of the distances L1, L2, and L3 is calculated by measuring an elapsed time, from when the transmitter of the ultrasonic wave sensor 21 emits an ultrasonic wave, to when the ultrasonic wave is emitted to the paper surface 2s of the banknote bundle 2A and the receiver receives a reflected wave of the ultrasonic wave from the paper surface 2s. Here, when the distance between each of the ultrasonic wave sensors 21 and the paper surface 2s of the banknote bundle 2A is defined as L [mm], the round-trip time during which the ultrasonic wave reciprocates in the distance L is defined as T [s], and the propagation speed in the air is defined as V [m/s], L is obtained by L=V×T×(½).

Subsequently, the controller 11 calculates distance differences |S1|, |S2|, and |S3|, which are absolute values of respective differences between the respective distances L1, L2, and L3 of the respective ultrasonic wave sensors 21 described above.

$$\vert S 1 \vert = \vert ( L 1 - L 2 ) \vert$$

$$\vert S 2 \vert = \vert ( L 1 - L 3 ) \vert$$

$$\vert S 3 \vert = \vert ( L 2 - L 3 ) \vert$$

Then, the controller 11 compares the distance differences |S1|, |S2|, and |S3| with a threshold value G for determining the presence or absence of the foreign substance 3, for example, 1.0 [mm], and determines that there is the foreign substance when any one of the distance differences |S1|, |S2|, and |S3| is equal to or larger than the threshold value G (|S|≥G). On the other hand, when any one of the distance differences |S1|, |S2|, and |S3| is less than the threshold value G (|S|<G), the controller 11 determines that there is no foreign substance.

As illustrated in FIG. 5, in a case in which there is no foreign substance, the paper surface 2s of the banknote bundle 2A is flat without occurrence of a change of the paper surface due to the bulging, and the first distance L1, the second distance L2, and the third distance L3 between the respective ultrasonic wave sensors 21 and the paper surface 2s of the banknote bundle 2A, are equal to each other. Therefore, each of the distance differences |S1|, |S2|, and |S3| becomes “0”, and the controller 11 determines that there is no foreign substance.

As an example, as illustrated in FIG. 6, in a case in which the foreign substance 3 is located near the center of the paper surface 2s of the banknote bundle 2A and there is a foreign substance, a change due to the bulging of the paper surface 2s, occurs at the second position P2 corresponding to the second ultrasonic wave sensor 21-2. Therefore, the second distance L2 between the second ultrasonic wave sensor 21-2 and the second position P2 on the paper surface 2s of the banknote bundle 2A, is smaller than the first distance L1 between the first ultrasonic wave sensor 21-1 and the first position P1 on the paper surface 2s of the banknote bundle 2A, and is smaller than the third distance L3 between the third ultrasonic wave sensor 21-3 and the third position P3 on the paper surface 2s of the banknote bundle 2A (L2<L1, L2<L3), and the first distance L1 and the third distance L3 are equal to each other (L1=L3). At this time, in a case in which the distance difference |S1| between the second distance L2 and the first distance L1, and the distance difference |S3| between the second distance L2 and the third distance L3, are equal to or larger than the threshold value G, the controller 11 determines that there is a foreign substance.

### Frequency of Ultrasonic Wave

The frequencies of ultrasonic waves respectively emitted from the transmitters of the ultrasonic wave sensors 21, are set such that the amount of change in the paper surface 2s of the banknote bundle 2A due to the foreign substance 3, that is, the resolution for detecting the distance L between the paper surface 2s of the banknote bundle 2A and the ultrasonic wave sensor 21, is 0.1 [mm] or less. When a wavelength of the ultrasonic wave is λ, the propagation speed in the air is defined as V, and the frequency of the ultrasonic wave is defined as f, λ=(V/f), and the frequency f of the ultrasonic wave is obtained by f=(V/λ).

Since the function of the above-described distance L, which is the amount of change in the paper surface 2s of the banknote bundle 2A, is determined by the wavelength of the ultrasonic wave, when λ=0.1 [mm] and V=340 [m/s], the frequency f of the ultrasonic wave is f=(V/λ)={(340 [m/s]×10³)/0.1 [mm]}/10⁶=3.40 [MHz].

Therefore, the detector 7 can detect the change amount of 0.1 [mm] or less of the paper surface 2s that bulges by the foreign substance 3, by irradiating the paper surface 2s of the banknote bundle 2A with the ultrasonic wave having the frequency f of 3.4 [MHz] or more by each ultrasonic wave sensor 21, and the resolution for detecting the foreign substance 3 such as the coin, is appropriately secured.

Based on the detection results of the respective ultrasonic wave sensors 21, the controller 11 determines that there is a foreign substance when any one of the above-described distance differences |S1|, |S2|, and |S3| is 1.0 [mm] or more. The threshold value G for determining the presence or absence of the foreign substance 3, is set to 1.0 [mm] or more, for example, based on the fact that the thickness of a coin used in Japan is approximately 1.5 [mm] to 1.8 [mm], and the dimensions of a typical banknote clip, but the present invention is not limited thereto. The threshold value G is appropriately set based on the thickness of the coin or the like used in the environment where the banknote handling apparatus 1 is installed.

### Detection Operation of Foreign Substance in Banknote Handling Apparatus

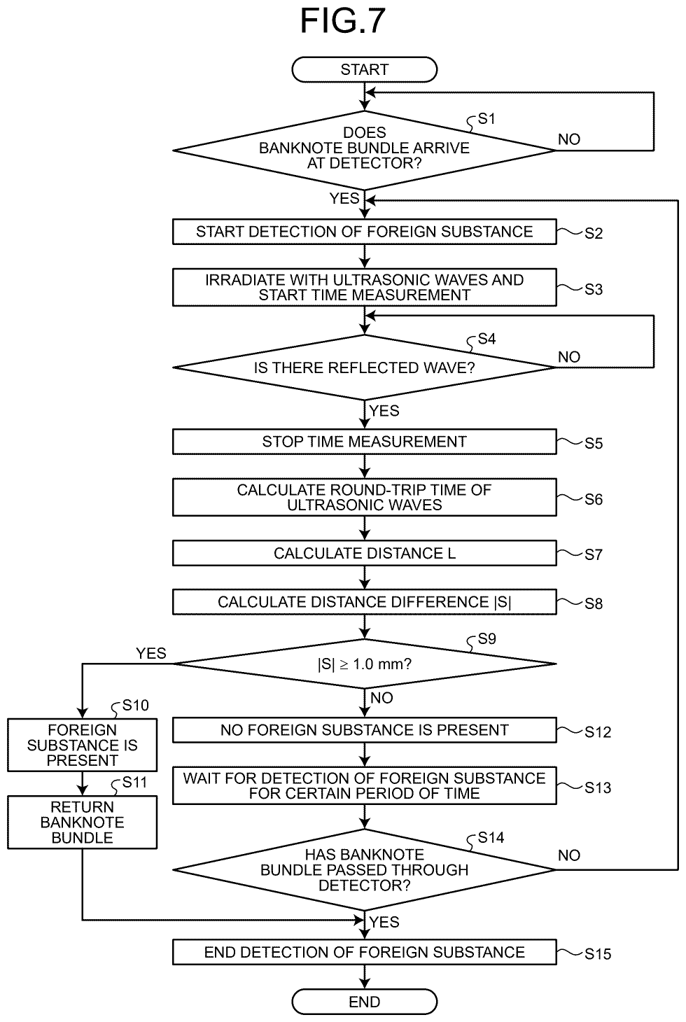

FIG. 7 is a flowchart for describing detection operation of the foreign substance 3 in the banknote handling apparatus 1 according to the embodiment.

When the banknote bundle 2A, which is inserted from the insertion port 4, is drawn into the shuttle 13 by the transfer belt 14, the banknote handling apparatus 1 presses the banknote bundle 2A in the thickness direction (Z direction) of the banknote bundle 2A by the plurality of rollers 25, in a state in which the banknote bundle 2A is sandwiched between the upper shuttle member 13A and the lower shuttle member 13B. As a result, the banknote bundle 2A, which is placed in the shuttle 13, is prevented from bulging on the paper surface 2s due to the wrinkles or the folding habit of the banknote 2 of the banknote bundle 2A, and is sent to the detector 7 by the conveyance mechanism 6, as illustrated in FIGS. 1 and 2.

As illustrated in FIG. 7, in the banknote handling apparatus 1, the position sensor 23 of the detector 7 detects the banknote bundle 2A, which is conveyed by the conveyance mechanism 6, and the controller 11 determines whether the banknote bundle 2A has arrived at the detector 7 (Step S1). In Step S1, when the banknote bundle 2A does not arrive at the detector 7 (NO), the banknote handling apparatus 1 continues the detection of the banknote bundle 2A by the position sensor 23. In Step S1, when the banknote bundle 2A has arrived at the detector 7 (YES), the banknote handling apparatus 1 causes the detector 7 to start detecting the presence or absence of the foreign substance 3 (Step S2), irradiates the paper surface 2s of the banknote bundle 2A with ultrasonic waves by each ultrasonic wave sensor 21, and starts time measurement of the round-trip time T until each ultrasonic wave sensor 21 receives the reflected wave from the paper surface 2s (Step S3).

Subsequently, the banknote handling apparatus 1 causes the controller 11 to determine whether the reflected wave of the ultrasonic wave, which is reflected on the paper surface 2s of the banknote bundle 2A, has been detected by each ultrasonic wave sensor 21 (Step S4). In Step S4, when the reflected wave is not detected by ultrasonic wave sensor 21 (NO), the ultrasonic wave sensor 21 continues detecting the reflected wave. In Step S4, when the reflected wave is detected by the ultrasonic wave sensor 21 (YES), the time measurement of the round-trip time T is stopped at the time point the reflected wave is received (Step S5).

Next, the banknote handling apparatus 1 causes the controller 11 to calculate the round-trip time T of the ultrasonic wave for each of the ultrasonic wave sensors 21 based on the detection result from each of the ultrasonic wave sensors 21 (Step S6). The controller 11 calculates the distance L (L1, L2, and L3) for each ultrasonic wave sensor 21 using the round-trip time T (Step S7), and calculates the distance difference |S| (|S1|, |S2|, and |S3|) using the distance L (Step S8).

Subsequently, the banknote handling apparatus 1 causes the controller 11 to determine whether each distance difference |S| (|S1|, |S2|, and |S3|) of each ultrasonic wave sensor 21, is 1.0 [mm] or more (|S|≥1.0 [mm]) (Step S9). In Step S9, when the distance difference |S| is 1.0 [mm] or more (YES), the controller 11 determines that there is a foreign substance, which is mixed in the banknote bundle 2A (Step S10), and returns the banknote bundle 2A to a user by returning the banknote bundle 2A to the insertion port 4 by the conveyance mechanism 6 (Step S11). Accordingly, the banknote handling apparatus 1 ends the detection of the foreign substance 3 (Step S15).

In Step S9, when the distance difference |S| is less than 1.0 [mm] (NO), the controller 11 determines that there is no foreign substance, which is mixed in the banknote bundle 2A (Step S12), and waits for the detector 7 to detect the presence or absence of the foreign substance 3 for a certain period of time, that is, temporarily stops the detection of the foreign substance 3 (Step S13). The banknote handling apparatus 1 causes the conveyance mechanism 6 to convey the banknote bundle 2A by a certain conveyance distance, by waiting for a certain period of time in Step S13.

Subsequently, the banknote handling apparatus 1 causes the controller 11 to determine whether the banknote bundle 2A is detected by the position sensor 23, in other words, whether the banknote bundle 2A has passed through the detector 7 (Step S14). When the banknote bundle 2A has passed through the detector 7 in Step S14 (YES), the banknote handling apparatus 1 ends the detection of the foreign substance 3 (Step S15). On the other hand, when the banknote bundle 2A has not passed through the detector 7 in Step S14 (NO), the banknote handling apparatus 1 returns to Step S2 again, and continues the detection of the presence or absence of the foreign substance 3.

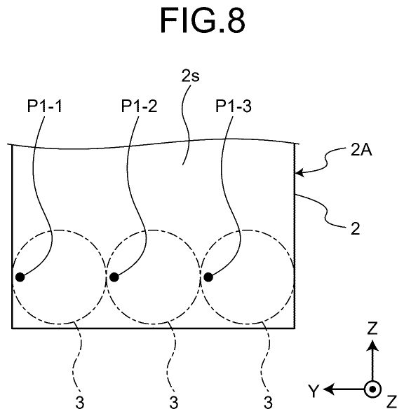

Here, the waiting time for waiting for a certain period of time in Step S13, will be described. FIG. 8 is a schematic diagram for describing a state in which the detection of the presence or absence of the foreign substance 3 is repeated a plurality of times at regular intervals in the conveyance direction (Y direction) of the conveyance path 5 in the embodiment.

In the present embodiment, as illustrated in FIG. 8, in a case in which the foreign substance 3 is a coin, when it is detected that the foreign substance 3 is not present at a position P1-1 by irradiating the position P1-1 with an ultrasonic wave, it is regarded that the foreign substance 3 is not present by a certain conveyance distance corresponding to the diameter dimension of the coin in the conveyance direction (Y) from the position P1-1. After performing the detection at the position P1-1, the detector 7 waits for the detection while the banknote bundle 2A moves by a certain conveyance distance, and after the banknote bundle 2A is conveyed by the diameter dimension of the coin, the detector 7 performs the detection at a next position P1-2. Similarly, after performing the detection at the position P1-2, the detector 7 waits for the detection while the banknote bundle 2A moves by a certain conveyance distance, and after the banknote bundle 2A is conveyed by the diameter dimension of the coin, the detector 7 performs the detection at a next position P1-3.

In the detection waiting time at this time, for example, when the diameter of the coin is 30 [mm] and the conveyance speed of the banknote bundle 2A is 1600 [mm/s], a conveyance time X for conveying the banknote bundle 2A by a certain conveyance distance corresponding to the diameter dimension of the coin is X=30 [mm]/(1600 [mm/s]×10³)=18.8 [ms].

Therefore, the detector 7 intermittently repeats the detection every time the banknote bundle 2A is sent by 18.8 [mm]. In the detector 7, the timing, at which detection is performed by the controller 11, is controlled based on the conveyance speed of the conveyance mechanism 6.

As a result, the detector 7 can detect the entire banknote bundle 2A in the conveyance direction (Y direction), and the number of times of detection can be maximally reduced. As a result, the banknote handling apparatus 1 shortens the detection time to detect the foreign substance 3 in the entire conveyance direction (Y direction) of the banknote bundle 2A, and can perform detection while conveying the banknote bundle 2A by the conveyance mechanism 6.

### Foreign Substance Detection Method

A description will be given as to a foreign substance detection method for detecting the foreign substance 3, which is mixed in the banknote bundle 2A, in the banknote handling apparatus 1 according to the embodiment that is configured as described above. The foreign substance detection method according to the embodiment includes: conveying the banknote bundle 2A along the conveyance path 5; respectively emitting ultrasonic waves from the plurality of ultrasonic wave sensors 21, which is arranged on the conveyance path 5, toward a plurality of positions (for example, the first position P1, the second position P2, and the third position P3) on the paper surface 2s of the banknote bundle 2A, which is conveyed along the conveyance path 5; and detecting presence or absence of the foreign substance 3, which is mixed in the banknote bundle 2A, based on the reflected waves of the respective ultrasonic waves from the plurality of positions. Note that the foreign substance detection method according to the embodiment is performed by the banknote handling apparatus 1, but may be applied to a program that causes a computer to execute detection in the foreign substance detection method and control of conveyance of the banknote bundle 2A, or a recording medium such as an optical disk in which the program is recorded.

### Effects of Embodiment

As described above, the banknote handling apparatus 1 according to the embodiment includes the conveyance path 5 on which the banknote bundle 2A is conveyed, and the detector 7 that is configured to detect presence or absence of the foreign substance 3, which is mixed in the banknote bundle 2A, by the plurality of ultrasonic wave sensors 21, which is arranged in the conveyance path 5, in which, in the detector 7, the plurality of ultrasonic wave sensors 21 respectively emit ultrasonic waves toward a plurality of positions (for example, the first position P1, the second position P2, and the third position P3) on the paper surface 2s of the banknote bundle 2A, which is conveyed along the conveyance path 5, and the presence or absence of the foreign substance 3 is detected based on the respective reflected waves of the ultrasonic waves from the plurality of positions. As a result, it is possible to appropriately detect the presence or absence of the foreign substance 3 regardless of the number of sheets of the banknote bundle 2A, and it is possible to improve the detection accuracy of the presence or absence of the foreign substance 3, which is mixed in the banknote bundle 2A. That is, according to the detector 7 of the present embodiment, for example, when detecting the presence or absence of the foreign substance 3 that is mixed in the banknote bundle 2A on which magnetic printing or the like is performed, it is possible to improve the detection accuracy as compared with a magnetic sensor or an ultrasonic wave sensor using the transmitted wave of the ultrasonic wave.

In addition, the detector 7 of the banknote handling apparatus 1 according to the embodiment repeats the detection of the presence or absence of the foreign substance 3 a plurality of times at regular intervals in the conveyance direction (Y direction) of the conveyance path 5 with respect to the paper surface 2s of the banknote bundle 2A. As a result, the detection can be performed over the entire conveyance direction (Y direction) of the paper surface 2s of the banknote bundle 2A, and the number of times of detection can be suppressed such that the detection is performed at an appropriate frequency. As a result, the detection time to detect the foreign substance 3 in the entire conveyance direction (Y direction) of the banknote bundle 2A, is shortened, and the detection can be performed while the banknote bundle 2A is conveyed by the conveyance mechanism 6.

In addition, the banknote handling apparatus 1 according to the embodiment includes the presser 8 having a plurality of rollers 25 that presses the banknote bundle 2A, which is conveyed along the conveyance path 5, in the thickness direction (Z direction) of the banknote bundle 2A. As a result, the bulging of the paper surface 2s, which is caused by the wrinkles or the folding habit of the banknote 2 of the banknote bundle 2A that is sent to the detector 7, is suppressed, and the bulging due to the foreign substance 3 can be appropriately detected, so that the detection accuracy of the foreign substance 3 can be improved.

In addition, the plurality of rollers 25 of the presser 8 in the banknote handling apparatus 1 of the embodiment is arranged in a grid pattern on the plane (X-Y plane) orthogonal to the thickness direction (Z direction) of the banknote bundle 2A conveyed along the conveyance path 5. As a result, the bulging of the paper surface 2s, which is caused by the wrinkles or the folding habit of the banknote 2 of the banknote bundle 2A that is sent to the detector 7, is further suppressed by the plurality of rollers 25, and the bulging due to the foreign substance 3 can be more appropriately detected, so that the detection accuracy of the foreign substance 3 can be further enhanced.

In addition, the banknote handling apparatus 1 according to the embodiment includes the conveyance mechanism 6 that conveys the banknote bundle 2A along the conveyance path 5. The conveyance mechanism 6 includes the pair of upper shuttle members 13A and lower shuttle members 13B each configured to convey the banknote bundle 2A in a state of sandwiching the banknote bundle 2A in the thickness direction (Z direction) of the banknote bundle 2A. The plurality of rollers 25 of the presser 8 is respectively provided on opposite surfaces (the lower surface 19 and the placement surface 20) of the pair of upper shuttle members 13A and the lower shuttle member 13B, in which the opposite surfaces face each other. As a result, the bulging of the paper surface 2s, which is caused by the wrinkles and the folding habit of the banknote 2 of the banknote bundle 2A, is easily suppressed by the plurality of rollers 25, and the bulging due to the foreign substance 3 can be more appropriately detected, so that the detection accuracy of the foreign substance 3 can be further enhanced.

In addition, the conveyance mechanism 6 of the banknote handling apparatus 1 of the embodiment includes the transfer belt 14 that moves the banknote bundle 2A, which is sandwiched between the pair of upper shuttle members 13A and lower shuttle members 13B, with respect to the plurality of rollers 25. As a result, it is possible to press the banknote bundle 2A in the thickness direction (Z direction) of the banknote bundle 2A, in a state of rolling the plurality of rollers 25 along the paper surface 2s of the banknote bundle 2A, and the bulging of the paper surface 2s, which is caused by the wrinkles or the folding habit of the banknote 2 of the banknote bundle 2A, is easily suppressed using the plurality of rollers 25, and the bulging of the paper surface 2s due to the foreign substance 3 can be more appropriately detected, thereby making it possible to further improve the detection accuracy of the foreign substance 3.

In addition, the plurality of ultrasonic wave sensors 21 of the detector 7 in the banknote handling apparatus 1 according to the embodiment is arranged in the grid pattern on the plane (X-Y plane) orthogonal to the thickness direction (Z direction) of the banknote bundle 2A, which is conveyed along the conveyance path 5. As a result, the detection accuracy of the foreign substance 3 can be enhanced, and the detection of the foreign substance 3 in a predetermined range of the paper surface 2s of the banknote bundle 2A, can be promptly performed.

In addition, the plurality of ultrasonic wave sensors 21 of the detector 7 in the banknote handling apparatus 1 according to the embodiment irradiates the paper surface 2s of the banknote bundle 2A with an ultrasonic wave having a frequency f of 3.4 [MHz] or more. As a result, a change amount of 0.1 [mm] or less of the paper surface 2s having bulging, which is caused by the foreign substance 3, can be detected, and a resolution for detecting the foreign substance 3 such as a coin can be appropriately secured.

According to one aspect of a paper sheet handling apparatus disclosed in the present application, it is possible to improve detection accuracy of the presence or absence of a foreign substance, which is mixed in the bundle of paper sheets.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A paper sheet handling apparatus comprising:
a conveyance path on which a bundle of paper sheets is conveyed; and
a detector that includes a plurality of ultrasonic wave sensors, which is arranged on the conveyance path, and detects, by the plurality of ultrasonic wave sensors, presence or absence of a foreign substance that is mixed in the bundle of paper sheets, wherein
the detector causes the plurality of ultrasonic wave sensors to respectively irradiate, with ultrasonic waves, a plurality of positions on a paper surface of the bundle of paper sheets, which is conveyed along the conveyance path, and detects the presence or absence of the foreign substance based on reflected waves of the ultrasonic waves from the plurality of positions.

2. The paper sheet handling apparatus according to claim 1, wherein
the detector repeatedly detects the presence or absence of the foreign substance a plurality of times at regular intervals in a conveyance direction of the conveyance path with respect to the paper surface.

3. The paper sheet handling apparatus according to claim 1, further comprising
a presser including a plurality of rollers, each of the rollers pressing the bundle of paper sheets, which is conveyed along the conveyance path in a thickness direction of the bundle of paper sheets.

4. The paper sheet handling apparatus according to claim 3, wherein
the plurality of rollers is arranged in a grid pattern on a plane orthogonal to the thickness direction of the bundle of paper sheets, which is conveyed along the conveyance path.

5. The paper sheet handling apparatus according to claim 4, further comprising
a conveyance mechanism that conveys the bundle of paper sheets along the conveyance path, wherein
the conveyance mechanism includes a pair of conveyance members that convey the bundle of paper sheets while sandwiching the bundle of paper sheets in the thickness direction of the bundle of paper sheets, and
the plurality of rollers is respectively provided on opposite surfaces of the pair of conveyance members, the opposite surfaces facing each other.

6. The paper sheet handling apparatus according to claim 5, wherein
the conveyance mechanism includes a moving member that moves the bundle of paper sheets sandwiched between the pair of conveyance members with respect to the plurality of rollers.

7. The paper sheet handling apparatus according to claim 1, wherein
the plurality of ultrasonic wave sensors is arranged in a grid pattern on a plane orthogonal to a thickness direction of the bundle of paper sheets, which is conveyed along the conveyance path.

8. The paper sheet handling apparatus according to claim 1, wherein
the plurality of ultrasonic wave sensors irradiates the paper surface of the bundle of paper sheets with the ultrasonic waves each having a frequency of 3.4 [MHz] or more.

9. A foreign substance detection method comprising:
conveying a bundle of paper sheets along a conveyance path;
irradiating, with ultrasonic waves respectively emitted from a plurality of ultrasonic wave sensors, which is arranged on the conveyance path, a plurality of positions on a paper surface of the bundle of paper sheets, which is conveyed along the conveyance path; and
detecting presence or absence of a foreign substance, which is mixed in the bundle of paper sheets, based on reflected waves of the ultrasonic waves from the plurality of positions.
